(19) United States
(12) Patent Application Publication
(10) Pub. No.: US 2026/0109437 A1
(43) Pub. Date: Apr. 23, 2026

(54) MODULAR ROV DEPLOYMENT SYSTEM

(71) Applicant: Reel Power Licensing Corp., Oklahoma City, OK (US)

(72) Inventors: Christopher D. Rekieta, Houston, TX (US); James Mlodzianowski, Houston, TX (US)

(21) Appl. No.: 19/353,373

(22) Filed: Oct. 8, 2025

Related U.S. Application Data
(60) Provisional application No. 63/710,826, filed on Oct. 23, 2024.

(51) Int. Cl. B63C 3/06; B66D 1/12

(52) U.S. Cl. CPC B63C 3/06; B66D 1/12; B66D 2700/025

(57) ABSTRACT

A modular first top container stackable to a modular second bottom container wherein first top container may be adapted to spool in and out a tether, umbilical cord, and so forth to an ROV that may be housed in second bottom container during deployment and or retrieval as well as second bottom container and or first top container may be adapted to house a control system for the ROV that may or may not be manned for deploying, operating and retrieving the ROV.

### CROSS-REFERENCE TO RELATED APPLICATIONS

The present application claims priority from U.S. Provisional Patent Application Serial No. 63/710,826 filed on October 23, 2024, currently pending, and is expressly incorporated herein by reference in its entirety

### BACKGROUND OF INVENTION

### 1. Field of the Invention

In general, the present invention relates to a remotely operated vehicle (ROV) and other crafts for underwater operations. More particularly, the present invention provides a new device, system, and method of deploying an ROV that may have a non-armored tether that has buoyancy and provides a modular deployment system that can be removably positioned on various platforms quickly and efficiently.

### 2. Description of the Prior Art

Remotely operated vehicles (ROV) play a huge role in underwater operations, such as but not limited to, oil and gas drilling and production. It is very typical that work that needs be done in these operations is too deep for a human to do. It is also understood that ROV deployment systems typically rely on a fixed attachment to a ship and or subsea rig. It is also known that these support systems for ROVs require significant time to attach and integrate into a ship and or platform. This process has much to do with the fact that the tether to an ROV is usually referred to as “armored” tethers that are incredibly heavy making the support system for the ROV respectively heavy and built into the ship and or platform to support the weight of these prior art tethers.

The current state of the ROV deployment systems is typically fixed, unmovable, and requires a transportation system that is ship dependable. Thus, there is a need for an apparatus, process, and or system that provides a modular deployment system that can be removably positioned on various platforms quickly and efficiently as well as provide a less heavy and cumbersome tether. The above discussed limitations in the prior art are not exhaustive. The current invention provides an inexpensive, time saving, more reliable apparatus, method. and system for use with a ROV and other watercraft where the prior art fails.

### SUMMARY OF THE INVENTION

In view of the foregoing disadvantages inherent in the known types of ROV deployment systems now present in the prior art, the present invention provides a new and improved apparatus, system, and method of using the same. As such, the general purpose of the present invention, which will be described subsequently in greater detail, is to provide a new modular removably attachable deployment system for various platforms that may utilize a non-armored tether with buoyancy, which has all the advantages of the prior art devices and none and or fewer of the disadvantages.

It is, therefore, contemplated that the present invention may comprise a modular first top container stackable to a modular second bottom container wherein first top container may be adapted to spool in and out a tether, an umbilical cord, and so forth to an ROV that may be housed in second bottom container during deployment and or retrieval. It is also contemplated that second bottom container and or first top container may be adapted to house a control system for the ROV that may or may not be manned for deploying, operating, and retrieving the ROV. Still further, the tether may be generally buoyant and non-armored.

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in this application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

Therefore, it is an object of the present invention to provide a new and improved modular ROV deployment apparatus, system, and method of using the same that provides a lighter weight and having a buoyancy tether as opposed to an armored tether.

Furthermore, an object of the present invention is to provide a new and improved modular ROV deployment apparatus, system, and method of using the same that can be positioned on a ship, platform, and so forth easily and efficiently with a modular non-permanently attached structure and may need only an electrical power source for all operations.

It is a further object of the present invention to provide a new and improved modular ROV deployment apparatus, system, and method of using the same which is of a durable and reliable construction leading to a more a flexible platform and robust unit.

An even further object of the present invention is to provide a new and improved modular ROV deployment apparatus, system, and method of using the same, which is susceptible to a low cost of installation and labor, which accordingly is then susceptible to low prices of sale to the consumer industry, thereby making such a system economically available to those in the field.

Still another object of the present invention is to provide a new and improved modular ROV deployment apparatus, system, and method of using the same, which provides all of the advantages of the prior art while simultaneously overcoming some of the disadvantages normally associated therewith.

Furthermore, another object of the present invention is to provide a new and improved modular ROV deployment apparatus, system, and method of using the same that reduces transportation time from a fixed ROV platform to a mobile modular unit that can be airlifted, craned, shipped, and so forth more quickly than a fixed ROV system on a ship, platform, and so forth.

These, together with other objects of the invention, along with the various features of novelty, which characterize the invention, are pointed out with particularity in the claims annexed to and forming a part of this disclosure. For a better understanding of the invention, its operating advantages, and the specific objects attained by its uses, reference should be had to the accompanying drawings and descriptive matter in which there are illustrated preferred embodiments of the invention.

### BRIEF DESCRIPTION OF THE PICTORIAL ILLUSTRATIONS, GRAPHS, DRAWINGS, AND APPENDICES

The invention will be better understood and objects other than those set forth above will become apparent when consideration is given to the following detailed description thereof. Such description makes reference to the annexed pictorial illustrations, graphs, drawings, and appendices.

FIG. 1 is a general illustration of a preferred embodiment in accordance with the current invention depicting a stored ROV.

FIG. 2 is a general illustration of a preferred embodiment in accordance with the current invention depicting a deployed ROV.

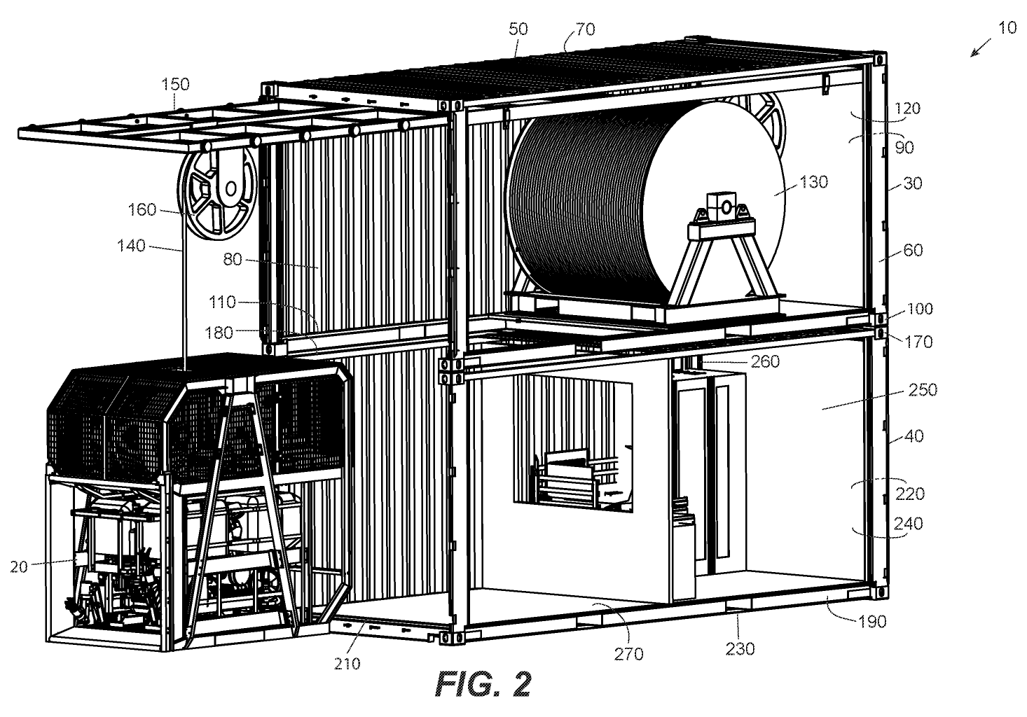

### DETAILED DESCRIPTION OF INVENTION

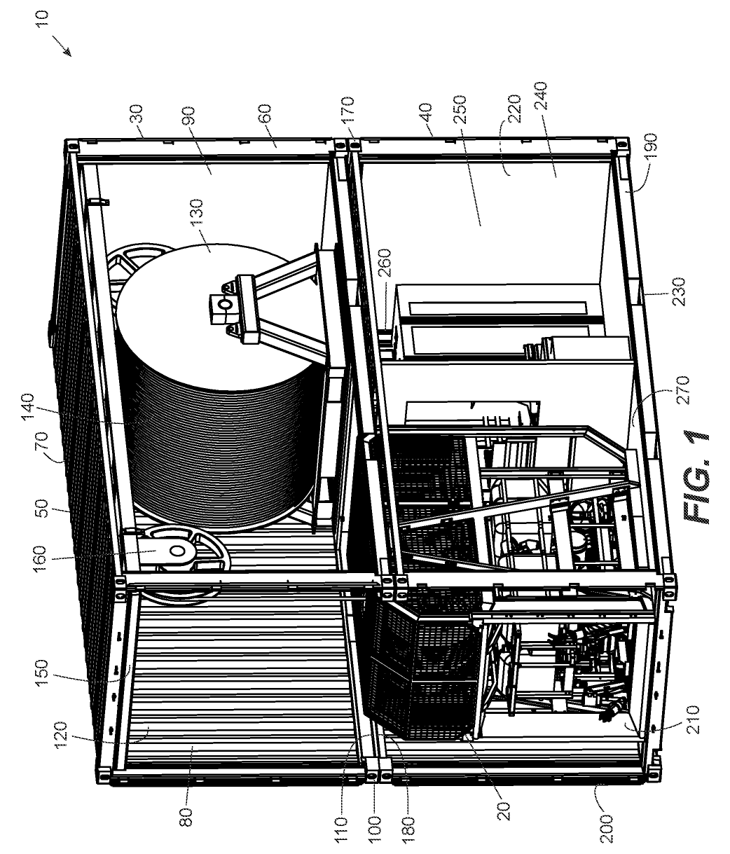

Referring to the illustrations, drawings, and pictures, and to FIG. 1 in particular, reference character 10 generally designates a new and improved modular deployment apparatus, system, and method of using the same for a remotely operated vehicle also referred to as an ROV 20 and or other underwater craft and machines constructed in accordance with the present invention. For purposes of convenience, the reference numeral 10 may generally be utilized for the indication of the invention, portion of the invention, preferred embodiments of the invention and so on. Invention 10 is generally used in subsea and or water operations but is not limited to same. Invention 10 may be positioned on land, dock, ship deck, offshore oil derrick, and so forth.

Invention 10 may generally include, but is not limited to, a modular first top container 30 stackable to a modular second bottom container 40. It is contemplated that first top container 30 and modular second bottom container 40 may be of standard shipping container sizes known in the industry although greater and lesser sizes are contemplated. This may allow for easier transportation by land, sea, and air thus allowing for speedy delivery to a variety of desired locations as needed and or on short notice for both and not limited offshore service work and military applications.

Modular first container 30, may have a top 50, a front side 60, a back side 70, a first openable side 80, a second openable side 90, a bottom 100 with an aperture 110, and an interior 120. Modular first top container 30 may have a motorized spool 130 for take up and pay out of a tether and or umbilical cord 140 and a motorized slide system 150 with a pulley 160 wherein motorized slide system 150 pulley 160 is positioned parallel to top 50 and adapted to extend out from and into interior 120 through first openable side 80.

Modular second bottom container 40 may have a top 170 with an aperture 180 aligned with bottom 100 aperture 110 of modular first top container 30, a front side 190, a back side 200, a first openable side 210, a second openable side 220, a bottom 230, and an interior 240. Modular second bottom container 40 interior 240 may have an operations and or control room 250 in communication via wire, wireless, and combination thereof connection 260 to motorized spool 130 for rotation of same, umbilical cord 140 for operation and control of the ROV functions, and the motorized slide system 150 for the deployment and retraction of same.

Modular second bottom container 40 interior 240 may have a storage section 270 inside interior 240 and below bottom 100 of first top container 30 aperture 110 and below aperture 180 of top 170 for storing and moving ROV 20 wherein the apertures 110 and 180 form a passageway for the umbilical cord 140 to move outward when ROV 20 is deployed and inward when being stored in storage section 270. It is understood that umbilical cord 140 is in contact with pulley 160 of motorized slide system 150 and ROV 20 is adapted to control operations of ROV 20, and raise and or lower the ROV 20.

It is understood that openable sides 80, 90, 210, and 220 respectively may have hinged doors, overhead retractable sliding doors, framed openings, combinations thereof and so forth. It is also understood that umbilical cord 140 may also be considered a tether, and so forth to ROV 20. Tether and or umbilical cord 140 may be buoyant and or partially buoyant. It is contemplated that tether and or umbilical cord 140 may be un-armored but may also be and or combinations thereof.

Therefore, invention 10 may be modular ROV deployment system comprising a modular first container having a top, a front side, a back side, a first openable side, a second openable side, a bottom with an aperture, and an interior having motorized spool for take up and pay out of an umbilical cord and a motorized slide with a pulley wherein said motorized slide with said pulley is positioned parallel to said top and adapted to extend out from and into said interior from said first openable side; a modular second container removably attached to said bottom of said first container having a top with an aperture aligned with said bottom aperture of said first container, a front side, a back side, a first openable side, a second openable side, a bottom, an interior with a control room in communication with said motorized spool, said umbilical cord, and said motorized slide, and a storage section below said aperture of said top adapted for holding and deploying said ROV through said openable first side of said second container; and wherein said umbilical cord from said motorized spool is in contact with said pulley of said motorized slide and said ROV and adapted to control operations of said ROV, raise and lower said ROV, and deploy and store said ROV.

Changes may be made in the combinations, operations, and arrangements of the various parts and elements described herein without departing from the spirit and scope of the invention. Furthermore, names, titles, headings, and general division of the aforementioned are provided for convenience and therefore, should not be considered limiting.

What is claimed is:

1. A modular ROV deployment system comprising:
a modular first container having a top, a front side, a back side, a first openable side, a second openable side, a bottom with an aperture, and an interior having motorized spool for take up and pay out of an umbilical cord and a motorized slide with a pulley wherein said motorized slide with said pulley is positioned parallel to said top and adapted to extend out from and into said interior from said first openable side;
a modular second container removably attached to said bottom of said first container having a top with an aperture aligned with said bottom aperture of said first container, a front side, a back side, a first openable side, a second openable side, a bottom, an interior with a control room in communication with said motorized spool, said umbilical cord, and said motorized slide, and a storage section below said aperture of said top adapted for holding and deploying said ROV through said openable first side of said second container; and
wherein said umbilical cord from said motorized spool is in contact with said pulley of said motorized slide and said ROV and adapted to control operations of said ROV, raise and lower said ROV, and deploy and store said ROV.
